(19) United States
(12) Patent Application Publication
(10) Pub. No.: US 2013/0234690 A1
(43) Pub. Date: Sep. 12, 2013

(54) POWER SUPPLY DEVICE

(71) Applicant: Takashi Matsutani, Yao-shi (JP)

(72) Inventor: Takashi Matsutani, Yao-shi (JP)

(73) Assignee: MegaChips Corporation, Osaka-shi (JP)

(21) Appl. No.: 13/882,896

(22) PCT Filed: May 23, 2011
(86) PCT No.: PCT/JP2011/061718

§ 371 Date: May 1, 2013

(30) Foreign Application Priority Data
Nov. 19, 2010 (JP) 2010 258716

(51) Int. Cl. H02M 3/156

(52) U.S. Cl. CPC H02M 3/156
USPC 323/282

(57) ABSTRACT

A power supply device includes a power supply circuit and a power information generation part. The power supply circuit performs voltage conversion in which an input voltage applied to a voltage input terminal is converted into a voltage having a predetermined voltage value, and outputs the voltage obtained as a result of the voltage conversion to a voltage output terminal. The power supply circuit includes a switching part for, by a switching operation thereof, chopping a voltage of the voltage input terminal side, and a control circuit that controls the switching operation of the switching part. The power information generation part generates power information concerning power that is outputted from the voltage output terminal based on a content of the switching operation.

### TECHNICAL FIELD

The present invention relates to a power supply device with a function for generating information concerning power.

### BACKGROUND ART

In general, a power measurement is implemented by computing with a voltage value measured by a voltage measurement circuit and a current value measured by a current measurement circuit. That is, the voltage measurement circuit and the current measurement circuit are necessary.

In a method introduced in Patent Document 1, a current sense resistor and a voltage sense resistor detect an AC voltage and an AC current that are supplied to a rectifier bridge diode of an AC/DC adapter, and detected values detected by these sense resistors are multiplied by each other, to thereby obtain a power value.

In a method introduced in Patent Document 2, a current is obtained by measuring a voltage drop in a switching transistor having an ON state in a switching power circuit.

### PRIOR-ART DOCUMENTS

### Patent Documents

[Patent Document 1] Japanese Patent Application Laid-Open No. 2010-29010
[Patent Document 2] Japanese Patent Application Laid-Open No. 7-198758 (1995)

### SUMMARY OF THE INVENTION

### Problems to be Solved by the Invention

In general, for the power measurement, it is necessary to add a voltage measurement circuit and a current measurement circuit as object circuits. This causes an increase in the costs and the like.

An object of the present invention is to provide a power supply device that is able to generate information concerning power with reduction of the costs and the like.

### Means for Solving the Problems

A power supply device according to a first aspect of the present invention includes: a power supply circuit that performs voltage conversion in which an input voltage applied to a voltage input terminal is converted into a voltage having a predetermined voltage value, and outputs the voltage obtained as a result of the voltage conversion to a voltage output terminal; and power information generation means for generating power information concerning power that is outputted from the voltage output terminal. The power supply circuit includes: switching means for, by a switching operation thereof, chopping a voltage of the voltage input terminal side; and a control circuit that controls the switching operation of the switching means. The power information generation means generates the power information based on a content of the switching operation.

A power supply device according to a second aspect is the power supply device according to the first aspect described above, in which: the control circuit controls the switching operation by giving a switching control signal to the switching means; the power information generation means includes derivation means in which the relationship between predetermined information and the power information is defined, the predetermined information including at least the content of the switching operation; and the power information generation means acquires the switching control signal and derives the power information by applying the content of the switching operation obtained from the switching control signal to the derivation means.

A power supply device according to a third aspect is the power supply device according to the second aspect described above, further including a voltage detector that is arranged to detect a voltage before the chopping is performed. The predetermined information further includes a voltage value of a portion detected by the voltage detector. The power information generation means derives the power information by applying the voltage value detected by the voltage detector and the content of the switching operation to the derivation means.

A power supply device according to a fourth aspect is the power supply device according to the second aspect described above, further including a voltage detector that is arranged to detect a voltage obtained after the chopping is performed. The predetermined information further includes a voltage value of a portion detected by the voltage detector. The power information generation means derives the power information by applying the voltage value detected by the voltage detector and the content of the switching operation to the derivation means.

A power supply device according to a fifth aspect is the power supply device according to the fourth aspect described above, in which the voltage detector is arranged to detect a voltage of the voltage output terminal.

A power supply device according to a sixth aspect is the power supply device according to the fourth or fifth aspect described above, in which the control circuit performs a feed-back control on the switching operation based on the voltage value detected by the voltage detector.

A power supply device according to a seventh aspect is the power supply device according to the second aspect described above, in which: the power supply circuit is a DC/DC converter; the predetermined information includes only the content of the switching operation; and the power information generation means generates the power information by using the derivation means and based only on the content of the switching operation obtained from the switching control signal.

A power supply device according to an eighth aspect is the power supply device according to any one of the first to seventh aspects described above, in which power line communication (PLC) is performed by using a power line that leads to the voltage input terminal.

A power supply device according to a ninth aspect is the power supply device according to the eighth aspect that recites the third to sixth aspects described above, in which the power supply device further includes a PLC processing circuit that performs a reception data extraction process in which data transmitted from another device to the power line is extracted from the voltage value detected by the voltage detector.

A power supply device according to a tenth aspect is the power supply device according to the eighth or ninth aspect described above, in which the control circuit modulates the switching operation in accordance with the data transmitted through the PLC.

### Effects of the Invention

In the first aspect described above, the power supply circuit performs the voltage conversion by using the chopping on the voltage of the voltage input terminal side. This chopping, and in other words, the switching operation of the switching means, determines the quantity of charge provided for the voltage conversion. This quantity of charge is correlated with the amount of an output current outputted from the voltage output terminal. In the first aspect, focusing this point, the content of the switching operation is used to generate the power information (information concerning the power outputted from the voltage output terminal), thereby eliminating the need for a current detector. This can reduce the cost, size, power consumption, and the like.

In the second aspect described above, the power information generation means obtains the content of the switching operation from the switching control signal. Accordingly, it is not necessary to provide a configuration for actual measurement of an operation status of the switching means. This enables the power information to be generated with a simple configuration. Therefore, the cost, size, power consumption, and the like, can be reduced accordingly.

In the third aspect described above, the voltage value before the chopping is performed, and in other words, the voltage value of the input side, is further used for the generation of the power information. This can reflect an actual operation status of the power supply circuit, and thus can improve the accuracy of the power information.

In the fourth aspect described above, the voltage value obtained as a result of the chopping, and in other words, the voltage value of the output side is further used for the generation of the power information. This can reflect an actual operation status of the power supply circuit, and thus can improve the accuracy of the power information.

In the fifth aspect described above, the power information is generated by using a stable voltage that is generated by the power supply circuit. This can improve the accuracy of the power information.

In the sixth aspect described above, the voltage detector can be shared between the control circuit and the power information generation means. This can reduce the cost, size, power consumption, and the like, as compared with a configuration in which separate voltage detectors are provided.

In the seventh aspect described above, the voltage value is not used for the generation of the power information. Therefore, it is not necessary to provide a voltage detector only for the purpose of generating the power information. Therefore, the cost, size, power consumption, and the like, can be reduced accordingly.

The eighth aspect described above enables the power supply device itself or a circuit connected to the power supply device to perform PLC.

In the ninth aspect described above, the voltage detector can be shared between the PLC processing circuit and the power information generation means. This can reduce the cost, size, power consumption, and the like, as compared with a configuration in which separate voltage detectors are provided.

In the tenth aspect described above, data transmission through PLC can be performed by using the switching operation of the switching means. That is, the power source function and the PLC transmission function share the switching means and the control circuit. Therefore, a line driver intended for PLC transmission is not necessary. As a result, the cost, size, power consumption, and the like, can be reduced accordingly.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1A block diagram illustrating a manner of use of a power supply device according to a first embodiment.

FIG. 2 A block diagram illustrating a configuration of the power supply device according to the first embodiment.

FIG. 3 A waveform chart illustrating a switching control signal according to the first embodiment.

FIG. 4 A block diagram illustrating a configuration of a power supply device according to a second embodiment.

FIG. 5 A block diagram illustrating a configuration of a power supply device according to a third embodiment.

FIG. 6 A block diagram illustrating a configuration of a power supply device according to a fourth embodiment.

FIG. 7 A block diagram illustrating a configuration of a power supply device according to a fifth embodiment.

FIG. 8 A waveform chart illustrating an operation of the power supply device according to the fifth embodiment.

FIG. 9 A block diagram illustrating a configuration of a power supply device according to a sixth embodiment.

FIG. 10 A block diagram illustrating a configuration of a power supply device according to a seventh embodiment.

### EMBODIMENT FOR CARRYING OUT THE INVENTION

### First Embodiment

<Manner of Use of Power Supply Device>

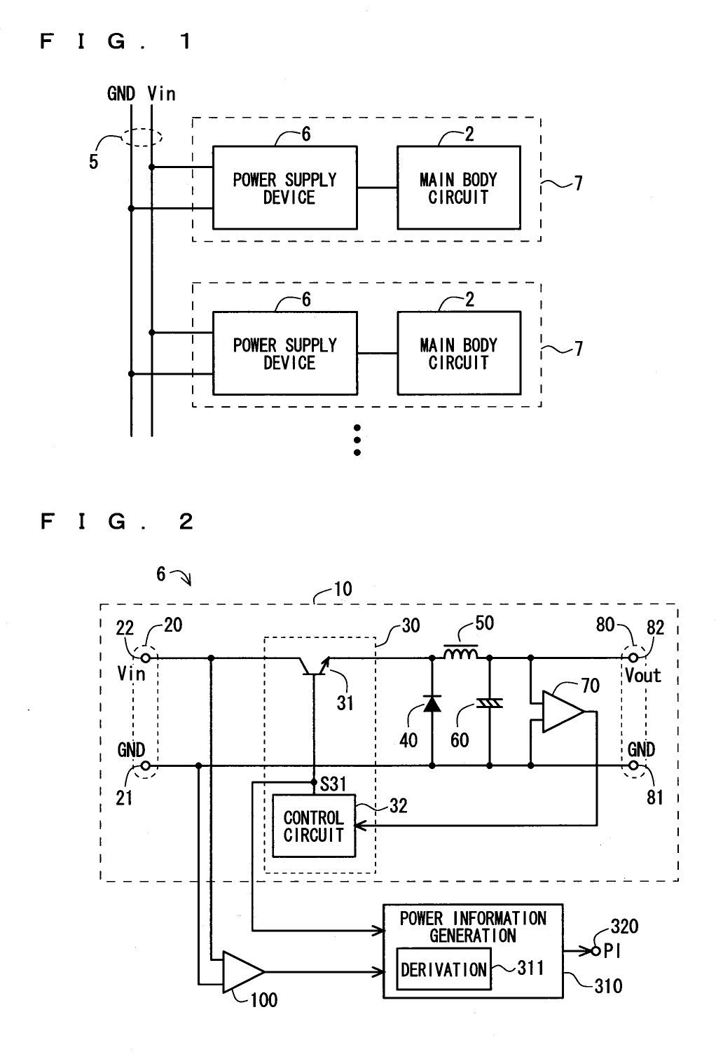

Prior to a description of an exemplary configuration of a power supply device 6 according to a first embodiment, a manner of use thereof will be illustrated with reference to the block diagram of FIG. 1.

In an example shown in FIG. 1, the power supply device 6 is used while being connected to a power line 5 and a main body circuit 2. In this manner of use, the power supply device 6 implements a power source function and a power information generation function. The power source function converts a supply voltage supplied from the power line 5 into a predetermined voltage value, and supplies the voltage obtained as a result of the conversion to the main body circuit 2. The power information generation function generates power information that is information concerning power supplied from the power supply device 6 to the main body circuit 2, and in other words, information concerning power consumption of the main body circuit 2. The main body circuit 2 corresponds to, for example, a personal computer (PC), various types of household electrical appliances, various types of batteries, and the like. The number of lines that connect the power supply device 6 to the main body circuit 2 is not limited to the illustrated example.

In the example shown in FIG. 1, a device 7 with power source function is configured including the power supply device 6 and the main body circuit 2, and a plurality of devices 7 with power source function are connected to the power line 5. The device 7 with power source function can exert various effects of the power supply device 6, which will be described later.

Here, the power supply device 6 and the main body circuit 2 may be accommodated in the same housing, or may be accommodated in different housings.

Additionally, the power supply device 6 may be provided in combination with a specific main body circuit 2 (that is, in the form of the device 7 with power source function), or may be provided alone (that is, in the form that allows the power supply device 6 to be subsequently combined with various main body circuits 2).

<Power Source Function>

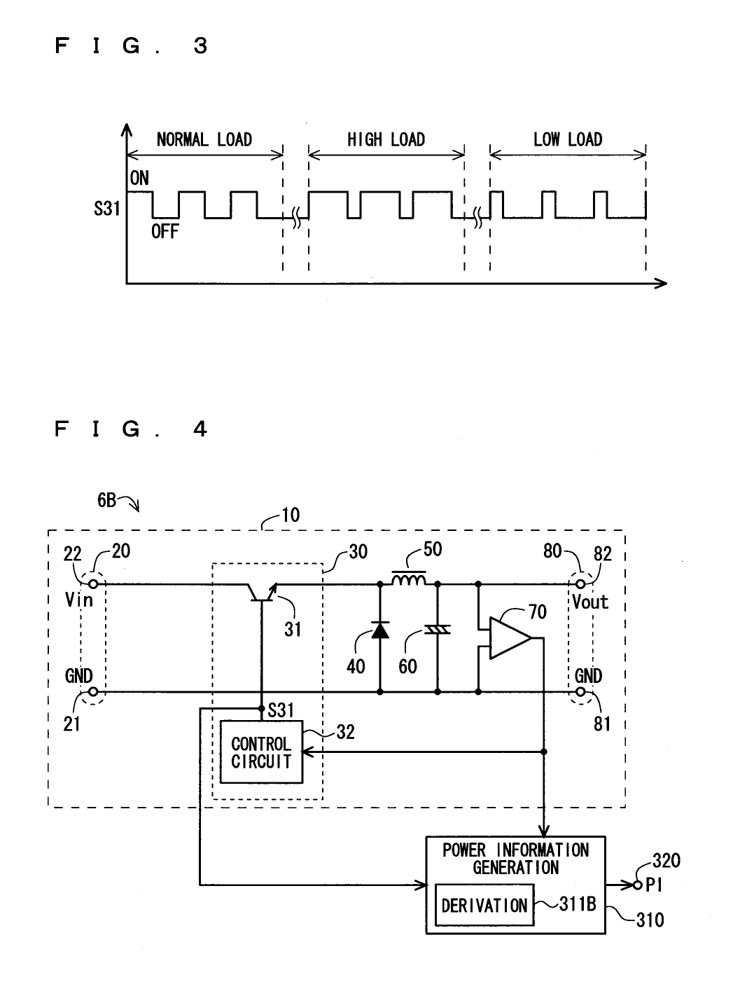

FIG. 2 is a block diagram illustrating a configuration of the power supply device 6. As shown in FIG. 2, the power supply device 6 includes a power supply circuit 10 that implements the above-mentioned power source function. The power supply circuit 10 illustrated in FIG. 2 is a DC/DC converter, which is classified into a non-isolated type, a switching type, and a step-down type. In an example shown in FIG. 2, the power supply circuit 10 includes a voltage input terminal 20, a switching circuit 30, a diode 40, an inductor 50, a capacitor 60, a voltage detector 70, and a voltage output terminal 80.

The voltage input terminal 20 is a part to which a voltage, and in other words, power, is supplied from the power line 5 (see FIG. 1). According to the example shown in FIG. 1, the voltage input terminal 20 corresponds to an external connection terminal that is connected to the power line 5 provided outside the power supply device 6. FIG. 2 illustrates a case where the voltage input terminal 20 includes input terminals 21 and 22, the terminal 21 is set at a ground potential GND, and a voltage Vin (here, a DC voltage) is applied across the terminals 21 and 22.

The input voltage Vin applied to the voltage input terminal 20 is subjected to voltage conversion performed by the power supply circuit 10, and thereby converted into a voltage Vout having a predetermined voltage value.

In the example shown in FIG. 2, the switching circuit 30 includes switching means 31 and a control circuit 32.

The switching means 31 is means for, by its switching operation, chopping a voltage of the voltage input terminal 20 side (in an exemplary configuration shown in FIG. 2, the input voltage Vin applied to the voltage input terminal 20). In the example shown in FIG. 2, the switching means 31 is implemented by a bipolar transistor. Therefore, the switching means 31 will be also referred to as a bipolar transistor 31 or a transistor 31. The transistor 31 has a collector thereof connected to the input terminal 22, an emitter thereof connected to the diode 40 and the inductor 50, and a base thereof connected to the control circuit 32.

As the switching means 31, various switching elements such as a MOSFET or various circuits that can implement the switching operation are adoptable. In a generalized sense, the switching means 31 includes one end (corresponding to the collector of the transistor 31), the other end (corresponding to the emitter of the transistor 31), and a control end (corresponding to the base of the transistor 31) to which a control signal is inputted. The control signal is for controlling a conducting/non-conducting state, and in other words, an ON/OFF state, between the one end and the other end. Based on the signal inputted to the control end, the conducting/non-conducting state between the one end and the other end is switched. Thereby, the voltage applied to the one end is chopped when appearing at the other end.

The control circuit 32 controls the switching operation of the switching means 31. The control circuit 32 is connected to the base of the transistor 31, and controls the ON/OFF state of the transistor 31 by applying a pulse-shaped switching control signal S31 to the base. Thereby, the transistor 31 chops the voltage Vin.

For simplification of the description, it is assumed that the transistor 31 is rendered conducting when the switching control signal S31 is at a High level (H level) and this conducting state is referred to as the ON state of the transistor 31. That is, it is assumed that there is a correspondence relationship among the H level of the switching control signal S31, the conducting state of the transistor 31, and the ON state of the transistor 31. In this case, there is a correspondence relationship among a Low level (L level) of the switching control signal S31, the non-conducting state of the transistor 31, and the OFF state of the transistor 31.

The control circuit 32 is configured to adjust, for example, the cycle and the duration of the H level of the switching control signal S31, thereby controlling a switching cycle (in other words, a switching frequency), an ON duration (that is, a time length during which the ON state continues), and the like, of the transistor 31. In this manner, a specific form of the switching operation of the transistor 3, and in other words, a specific form of chopping performed by the transistor 31, is controlled.

The diode 40 has a cathode thereof connected to the emitter of the transistor 31, and an anode thereof connected to the input terminal 21. The diode 40 is a so-called free-wheeling diode. The inductor 50 has one end thereof connected to the cathode of the diode 40, and the other end thereof connected to one end of the capacitor 60. The other end of the capacitor 60 is connected to the anode of the diode 40. A voltage across the ends of the capacitor 60 is a desired voltage Vout obtained as a result of voltage conversion.

Here, the voltage detector 70 is used to detect and measure the voltage Vout obtained as a result of the voltage conversion (that is, a voltage obtained as a result of the chopping). For example, an A/D (Analog/Digital) converter is adoptable as the voltage detector 70. Therefore, the voltage detector 70 will be sometimes referred to as an A/D converter 70.

In the example shown in FIG. 2, the A/D converter 70 has one input end thereof connected to the one end of the capacitor 60, the other input end thereof connected to the other end of the capacitor 60, and an output end thereof connected to the control circuit 32. Thereby, the voltage Vout across the ends of the capacitor 60 (that is, the voltage obtained as a result of voltage conversion) is detected, and this detected voltage value (that is, a measured voltage value) is subjected to A/D conversion and then supplied to the control circuit 32.

The voltage output terminal 80 is a part for extracting the converted voltage Vout generated from the input voltage Vin. FIG. 2 illustrates a case where the voltage output terminal 80 includes output terminals 81 and 82, the terminal 81 is connected to the other input end of the A/D converter 70, and the terminal 82 is connected to the one input end of the A/D converter 70. In this case, the terminal 81 is set at the ground potential GND, and the voltage Vout is obtained across the terminals 81 and 82. In the example shown in FIG. 1, the voltage output terminal 80 corresponds to an external connection terminal that is connected to the main body circuit 2 provided outside the power supply device 6.

The power supply circuit 10 is operated roughly as follows. That is, the input voltage Vin is chopped by the transistor 31 and smoothed by an LC filter including the inductor 50 and the capacitor 60, resulting in the output voltage Vout. As seen from this, the output voltage Vout is a voltage originating from the input voltage Vin and corresponding to the input voltage Vin. In general, in a switching type power supply circuit, unlike a so-called linear type power supply circuit, the amount of power (in other words, energy) taken from the power line 5 is, in principle, equal to the amount of power outputted from this power supply circuit.

A voltage value of the output voltage Vout can be controlled based on setting of the chopping performed on the input voltage Vin, and in other words, based on the cycle, the pulse width, and the like, of the switching control signal S31.

Accordingly, the control circuit 32 controls a pulse shape of the switching control signal S31 such that a difference between a detected value of the output voltage Vout obtained by the A/D converter 70 and a set value of the output voltage Vout which has been set in advance (feed-back control). In a case illustrated herein, a so-called pulse width modulation (Pulse Width Modulation; PWM) is adopted in which a pulse cycle is constant and an ON duration of the pulse (in other words, a duty cycle (=ON-duration/pulse-cycle) of the pulse) is controlled.

Thus, the control circuit 32 controls the chopping that the transistor 31 performs on the input voltage Vin, and performs voltage conversion to obtain a desired voltage value.

For the feed-back control mentioned above, a comparator may be used as the voltage detector 70. To be specific, it may be possible that the comparator detects the voltage Vout obtained as a result of conversion, compares this detected voltage value with the set value of the voltage Vout, and transmits to the control circuit 32 a signal concerning a result of the comparison. That is, comparison between the detected value and the set value of the output voltage Vout may be performed by the comparator instead of the control circuit 32.

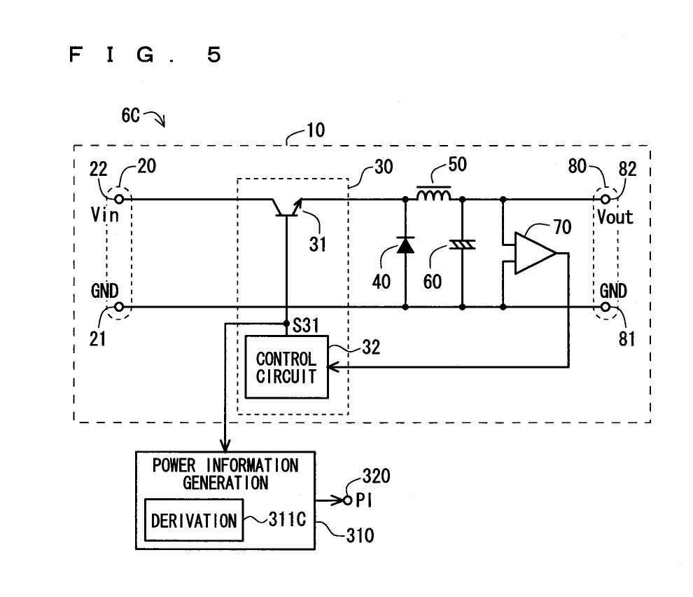

FIG. 3 illustrates a waveform of the switching control signal S31. As seen from FIG. 3, with a greater load (in other words, with higher power consumption in the main body circuit 2 (see FIG. 1)), the pulse width in an ON-period of the switching control signal S31 increases (in other words, the duty cycle (=ON-duration/pulse-cycle) of the pulse increases).

<Power Information Generation Function>

As shown in FIG. 2, the power supply device 6 further includes a voltage detector 100, power information generation means 310, and a power information output terminal 320, which are related to the power information generation function. In the drawings, “power information generation means” is abbreviated as “power information generation”. This manner of notation may be applied to other components.

Here, the voltage detector 100 is used to detect and measure the input voltage Vin applied to the voltage input terminal 20 (that is, the voltage before the chopping is performed). For example, an A/D converter is adoptable as the voltage detector 100. Therefore, the voltage detector 100 will be also referred to as an A/D converter 100.

In the example shown in FIG. 2, the A/D converter 100 has one input end thereof connected to the input terminal 22, the other input end thereof connected to the input terminal 21, and an output end thereof connected to the power information generation means 310. Accordingly, the voltage value of the input voltage Vin (before being chopped by the transistor 31) is detected, and such a detected voltage value (in other words, a measured voltage value) is subjected to A/D conversion, and inputted to the power information generation means 310.

The power information generation means 310 is connected to the output end of the A/D converter 100, an output end of the control circuit 32 (an end thereof that outputs the switching control signal S31), and the power information output terminal 320. This causes the power information generation means 310 to acquire the detected value of the input voltage Vin from the A/D converter 100 and also acquire the switching control signal S31 from the control circuit 32, and generate power information PI based on the detected value of the input voltage Vin and the switching control signal S31 thus acquired. Various processing and functions of the power information generation means 310 can be implemented by software (in other words, execution of a program), by a hardware circuit configuration, or by a combination thereof.

As described above, the power information PI is information concerning the power that is outputted from the power supply device 6 to the main body circuit 2, and in other words, information concerning the power consumption in the main body circuit 2. For example, the power information PI may be an instantaneous value or an integrated value of the output power of the power supply device 6, or alternatively may be a level value correlated with these values. The power information PI may not always be a numerical value but may be, for example, information indicating a result of comparison between this value and a predetermined value. The information indicating the result of comparison is usable to, for example, notification of the fact that the power exceeds a specified upper limit value or falls below a specified lower limit value.

The power information PI thus generated is, herein, outputted to the power information output terminal 320. That is, the power information PI can be extracted via the power information output terminal 320, and provided for, for example, management of the power consumption in the main body circuit 2, or for being displayed on the power supply device 6. It may be also acceptable that the power information PI is outputted to the outside of the device 7 with power source function (see FIG. 1) and used there.

Although FIG. 2 illustrates a case where the power information output terminal 320 is configured as one terminal, it is possible that the terminal 320 is configured with a plurality of terminals.

The power information generation means 310 is configured based on the following viewpoint. That is, as described above, the power supply circuit 10 performs the voltage conversion by using the chopping on the voltage of the voltage input terminal 20 side (herein, the input voltage Vin). The chopping, and in other words, the switching operation of the transistor 31, determines the quantity of charge (in other words, energy) provided for the voltage conversion. This quantity of charge is correlated with the output current value of the current outputted from the voltage output terminal 80. Accordingly, grasping the status of the switching operation of the transistor 31 enables information correlated with the output current outputted from the power supply circuit 10 to be obtained without using a current detector. In view of this, the power information generation means 310 is configured to generate the power information PI based on the status of the switching operation of the transistor 31. A specific example of the power information generation means 310 will be described below.

The power information generation means 310 has a derivation means 311. In the derivation means 311, the relationship between predetermined information and the power information PI is defined in advance. The predetermined information includes, in a case of the power supply device 6, the content of the switching operation of the transistor 31 and a voltage value of a portion that is a target for the voltage detection by the A/D converter 100. As information concerning the content of the switching operation, a time length of the ON state of the transistor 31 is illustrated herein. In such a case, the relationship among the time length of the ON state of the transistor 31, the voltage value of the portion detected by the A/D converter 100, and the power information PI are defined in the derivation means 311. The relationship among these three types of information can be obtained by, for example, an experiment, a circuit analysis, or the like. The relationship that has been obtained in advance is given to the derivation means 311. The derivation means 311 can be implemented by, for example, a look-up table (LUT), a program, an arithmetic expression, a computing circuit, or the like.

The information concerning the content of the switching operation is not limited to the above-mentioned example. For example, it is possible to adopt the cycle and the duty cycle of the switching operation.

The power information generation means 310 generates the power information PI by using the derivation means 311. More specifically, the power information generation means 310 acquires the switching control signal S31 from the control circuit 32, and therefore is able to acquire the content of the operation of the transistor 31 (herein, the time length of the ON state is illustrated) from the switching control signal S31. The power information generation means 310 applies the time length of the ON state of the transistor 31 that has been acquired in this mariner to “the time length of the ON state of the transistor 31” in the derivation means 311, and also applies the detected value of the input voltage Vin acquired from the A/D converter 100 to “the voltage value in the part detected by the A/D converter 100” in the derivation means 311. Application of the corresponding items in this manner causes the power information PI to be derived from the derivation means 311.

Here, the content of the switching operation of the transistor 31 is correlated with the quantity of charge taken from the power line 5 (see FIG. 1), and the voltage detected by the A/D converter 100 is correlated with the supply voltage supplied from the power line 5. Therefore, it is possible to regard the derivation means 311 as means for deriving the power information PI based on the supply power supplied from the power line 5.

<Effects, etc.>

The power supply device 6 uses the content of the switching operation of the transistor 31 in order to generate the power information PI, thereby eliminating the need for a current detector. As a result, the cost, size, power consumption, and the like, can be reduced.

The power information generation means 310 acquires the content of the switching operation of the transistor 31 from the switching control signal S31. Instead, it may be also possible that, for example, a configuration for actual measurement of the operation status of the transistor 31 is provided in order to acquire the content of the switching operation. However, use of the switching control signal S31 can generate the power information PI with a simpler configuration, and the cost, size, power consumption, and the like, can be reduced accordingly.

For the generation of the power information PI, not only the content of the operation of the transistor 31 but also the detected voltage value detected by the A/D converter 100 (more specifically, the voltage value prior to the chopping, and in other words, the voltage value of the input side) is used. This can reflect an actual operation status of the power supply circuit 10, and thus can improve the accuracy of the power information PI.

### Second Embodiment

FIG. 4 is a block diagram illustrating a configuration of a power supply device 6B according to a second embodiment. The power supply device 6B can be also combined with the main body circuit 2 (see FIG. 1).

The power supply device 6B has a configuration similar to that of the power supply device 6 described above (see FIG. 2), but the A/D converter 100 (see FIG. 2) is not provided. Additionally, the power information generation means 310 is configured to acquire an output of the A/D converter 70. Moreover, instead of the derivation means 311 (see FIG. 2), derivation means 311B is provided. The other parts of the configuration of the power supply device 6B are basically the same as those of the power supply device 6 described above.

The power information generation means 310 of the power supply device 6B acquires the switching control signal S31 from the control circuit 32, and also acquires the detected value of the output voltage Vout (that is, the voltage obtained as a result of the chopping) from the A/D converter 70. The power information generation means 310 generates the power information PI based on the switching control signal S31 and the detected value of the output voltage Vout that have been acquired. Thus, instead of the detected voltage value detected by the A/D converter 100 (see FIG. 2), a detected voltage value detected by the A/D converter 70 that has already existed in the power supply circuit 10.

According to such a configuration, the derivation means 311B adopts the voltage value Vout of a portion that is a target for the voltage detection by the A/D converter 70, instead of the voltage value Vin of the portion that is a target for the voltage detection by the A/D converter 100 (see FIG. 2). That is, in the derivation means 311B, the predetermined information associated with the power information PI includes the content of the switching operation of the transistor 31 and the voltage value Vout of the portion that is a target for the voltage detection by the A/D converter 70.

The fact that the detection target voltage value Vout, Vin detected by the A/D converter 70, 100 has correlation can be grasped by an experiment, a circuit analysis, or the like. Accordingly, the above-described configuration in which the derivation means 311B adopts the voltage value Vout instead of the voltage value Vin is allowed. In view of this point, it is also possible to generate the power information PI by using a voltage of a portion other than the voltage input terminal 20 and the voltage output terminal 80.

The power information generation means 310 generates the power information PI by using the derivation means 311B in the same manner as the derivation means 311 described above.

Similarly to the power supply device 6 described above (see FIG. 2), the power supply device 6B eliminates the need for a current detector, and the cost, size, power consumption, and the like, can be reduced accordingly.

Similarly to a case of the power supply device 6 described above, the power information generation means 310 acquires the content of the switching operation of the transistor 31 from the switching control signal S31. This enables simplification of the configuration and reduction of the cost, size, power consumption, and the like.

Additionally, for the generation of the power information PI, not only the content of the operation of the transistor 31 but also the detected voltage value detected by the A/D converter 70 (more specifically, the voltage value obtained as a result of the chopping, and in other words, the voltage value of the output side) is used. This can reflect an actual operation status of the power supply circuit 10, and thus can improve the accuracy of the power information PI.

Moreover, the power information PI is generated by using the output voltage Vout of the voltage output terminal 80. The input voltage Vin may sometimes contain noise caused by, for example, an operation of the transistor 31 or an operation of another device connected to the power line 5. On the other hand, the output voltage Vout is a stable voltage that is generated by the power supply circuit 10. Using such a stable voltage Vout to generate the power information PI can improve the accuracy of the power information PI.

Furthermore, since the control circuit 32 and the power information generation means 310 share the A/D converter 70, the cost, size, power consumption, and the like can be reduced as compared with a configuration in which separate voltage detectors are provided.

### Third Embodiment

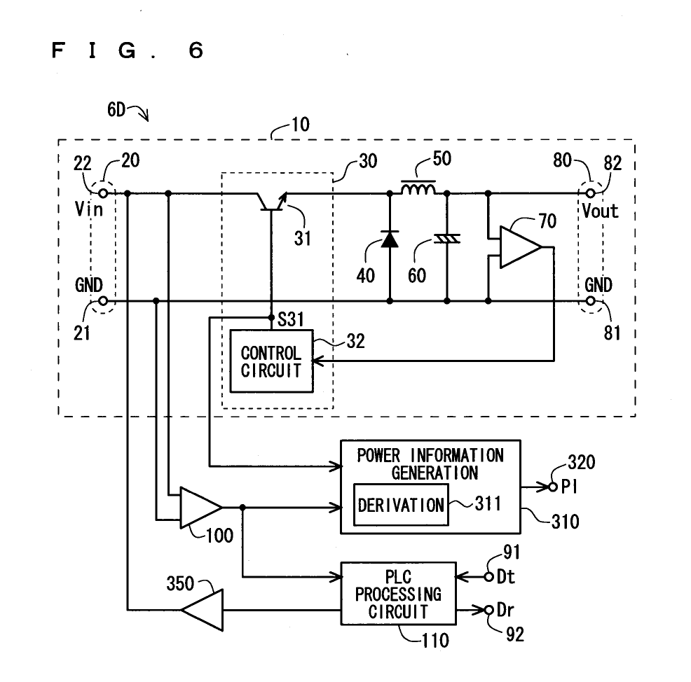

FIG. 5 is a block diagram illustrating a configuration of a power supply device 6C according to a third embodiment. The power supply device 6C can be also combined with the main body circuit 2 (see FIG. 1).

The power supply device 6C has a configuration similar to that of the power supply device 6 described above (see FIG. 2), but the A/D converter 100 (see FIG. 2) is not provided. Additionally, instead of the derivation means 311 (see FIG. 2), derivation means 311C is provided. The other parts of the configuration of the power supply device 6C are basically the same as those of the power supply device 6 described above.

The power information generation means 310 of the power supply device 6C acquires the switching control signal S31 from the control circuit 32, but unlike the power supply devices 6 and 6B described above (see FIGS. 2 and 4), does not acquire the detected voltage value detected by the A/D converter 100, 70. Accordingly, the power information generation means 310 generates the power information PI based only on the switching control signal S31 that has been acquired.

According to such a configuration, the relationship between the content of the switching operation of the transistor 31 and the power information PI is defined in the derivation means 311C. That is, in the derivation means 311C, the predetermined information associated with the power information PI includes only the content of the switching operation of the transistor 31.

The power information generation means 310 generates the power information PI by using the derivation means 311C in the same manner as the derivation means 311 described above.

Similarly to the power supply device 6 described above (see FIG. 2), the power supply device 6C eliminates the need for a current detector, and the cost, size, power consumption, and the like, can be reduced accordingly.

Similarly to a case of the power supply device 6 described above, the power information generation means 310 acquires the content of the switching operation of the transistor 31 from the switching control signal S31. This enables simplification of the configuration and reduction of the cost, size, power consumption, and the like.

Additionally, since no voltage value is used for the generation of the power information PI, it is not necessary to provide a voltage detector only for the purpose of generating power information. Therefore, the cost, size, power consumption, and the like, can be reduced accordingly.

In the power supply circuit 10 that is a DC/DC converter, the input voltage Vin is a known DC voltage because of design. Therefore, the amount of power taken from the power line 5 can be grasped based only on the content of the operation of the transistor 31. In view of this point, the power supply device 6C can generate the power information PI without using the voltage value for the generation of the power information PI.

### Fourth Embodiment

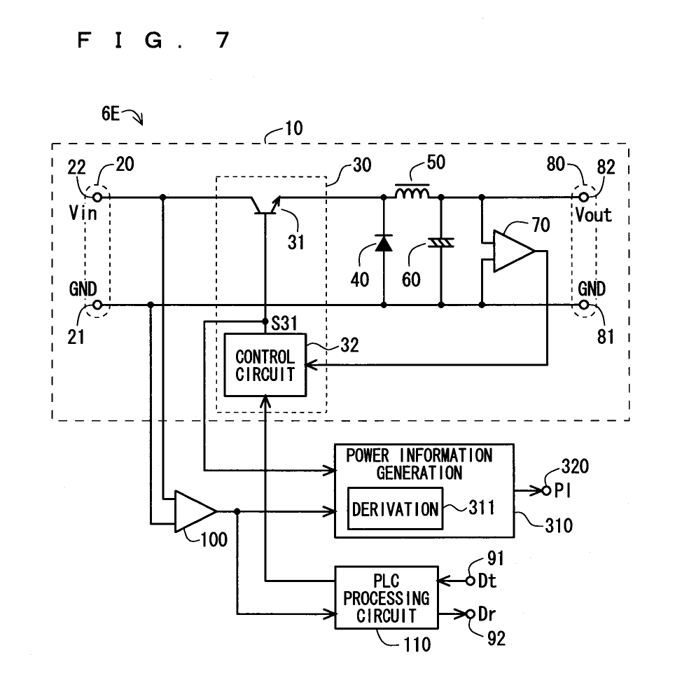

FIG. 6 is a block diagram illustrating a configuration of a power supply device 6D according to a fourth embodiment. The power supply device 6D can be also combined with the main body circuit 2 (see FIG. 1). The power supply device 6D has, in addition to the power source function and the power information generation function described above, a communication function for performing PLC through the power line 5.

The power supply device 6D has a configuration in which a data input terminal 91, a data output terminal 92, a PLC processing circuit 110 and a line driver 350 are additionally provided to the power supply device 6 described above (see FIG. 2).

The data input terminal 91 is a part to which data Dt to be transmitted to the power line 5 (see FIG. 1) is inputted. In a case where, for example, the main body circuit 2 (see FIG. 1) performs PLC by using the power supply device 6D, the data input terminal 91 corresponds to the external connection terminal that is connected to the main body circuit 2. The transmission data Dt is supplied from the main body circuit 2 to the data input terminal 91.

The data output terminal 92 is a part for extracting data Dr received from the power line 5 (see FIG. 1). In a case where, for example, the main body circuit 2 (see FIG. 1) performs PLC by using the power supply device 6D, the data output terminal 92 corresponds to the external connection terminal that is connected to the main body circuit 2. The reception data Dr is supplied to the main body circuit 2 via the data output terminal 92.

Although FIG. 6 illustrates a case where the data input terminal 91 is configured as one terminal, the data input terminal 91 may be configured with a plurality of terminals. The same applies to the data output terminal 92.

The PLC processing circuit 110 is connected to the data input terminal 91, the data output terminal 92, an input end of the line driver 350, and the output end of the A/D converter 100.

The PLC processing circuit 110 performs various kinds of processing concerning the PLC (broadly divided into a transmission process and a reception process).

In the transmission process, for example, the PLC processing circuit 110 performs a predetermined transmission baseband process on the transmission data Dt inputted to the data input terminal 91, and thereby generates a baseband signal.

Examples of the transmission baseband process include a process for adding information (such as error control information) concerning a control and a process for dividing data into a predetermined size. Contents of the transmission process are defined in accordance with a protocol that has been adopted in advance.

The PLC processing circuit 110 subjects the generated baseband signal to D/A (Digital/Analog) conversion as necessary, and then outputs the resultant signal to the line driver 350.

In an example shown in FIG. 6, an output end of the line driver 350 is connected to the voltage input terminal 22. The line driver 350 controls its own output voltage value in accordance with the baseband signal acquired from the PLC processing circuit 110 (therefore, in accordance with the transmission data Dt). As a result, the transmission data Dt is transmitted to the power line 5 (see FIG. 1).

Indeed, it is possible to use the transmission data Dt as the baseband signal without any change made thereto by the PLC processing circuit 110, but performing various types of data processing by the PLC processing circuit 110 can improve the reliability of communication.

In the reception process, on the other hand, the PLC processing circuit 110 performs a predetermined reception baseband process on an output signal of the A/D converter 100 (that is, a detected voltage of the input voltage Vin), and thereby extracts data transmitted from another device to the power line 5 (see FIG. 1) (reception data extraction process).

Examples of the reception baseband process include a process for extracting a baseband signal from an output signal of the A/D converter 100, a process in accordance with information (such as error control information) concerning a control which is added to the baseband signal, a process for restoring data having been transmitted in a divided form, and a process for determining whether or not received data is data addressed to the power supply device 6D. Contents of the reception process are defined in accordance with a protocol that has been adopted in advance.

The power supply device 6D exerts the same effects as those of the power supply device 6 described above (see FIG. 2), and additionally enables PLC to be performed by the power supply device 6D itself or the main body circuit 2 or the like that is connected to the power supply device 6D.

Since the PLC processing circuit 110 and the power information generation means 310 share the A/D converter 100, the cost, size, power consumption, and the like can be reduced as compared with a configuration in which separate voltage detectors are provided.

It is also possible to add the PLC function to the power supply device 6B, 6C (see FIGS. 4 and 5) or the like by an application of the various configurations described above.

It is also possible that the PLC processing circuit 110 is configured to perform the reception data extraction process on the detected voltage detected by the A/D converter 70.

In this case, the A/D converter 70 is connected to the voltage output terminal 80 side relative to a position where the transistor 31 is connected and, unlike the A/D converter 100 (see FIG. 6), connected to a position on the circuit which is distant from the voltage input terminal 20. Therefore, when the detected voltage detected by the A/D converter 70 is used, it may be difficult to perform the reception data extraction process with the same accuracy as in the power supply device 6D described above.

In such a case, it may be possible that the PLC processing circuit 110 estimates the input voltage Vin based on the detected voltage (originating from the input voltage Vin and corresponding to the input voltage Vin) detected by the A/D converter 70, and the reception data extraction process is performed on this estimated voltage. The estimation of the input voltage Vin can be performed based on information of a circuit configuration between the voltage input terminal 20 and the A/D converter 70. The information of the circuit configuration can be given to the PLC processing circuit 110, by mathematizing the circuit configuration or by obtaining a correspondence relationship between input and output values of the circuit configuration and making a database thereof. A mathematical expression, a database, and the like, of the information of the circuit configuration may be provided as hardware (such as a digital filter) or may be provided as software (in other words, a program process).

Use of an input voltage estimation process can ensure an accuracy of the reception data extraction process, that is, a reliability of data reception, even in a case where a circuit is interposed between the voltage input terminal 20 and the A/D converter 70. In other words, the degree of freedom in a position where the A/D converter used for the data reception is connected is increased.

In view of the above, in a case where the PLC function is added to the power supply device 6B described above (see FIG. 4), the A/D converter 70 can be shared among the power supply circuit 10, the power information generation means 310, and the PLC processing circuit 110. This can reduce the cost, size, power consumption, and the like.

Here, in a case of performing the reception data extraction process on the output of the A/D converter 70, the PLC processing circuit 110 preferably performs the reception data extraction process on a portion of the detected voltage detected by the A/D converter 70 corresponding to the ON-period of the transistor 31. Such a reception operation can be achieved by the PLC processing circuit 110 acquiring the switching control signal S31 and performing the reception data extraction process in synchronization with the control signal S31.

This is because the A/D converter 70 is connected to the voltage output terminal 80 side relative to the position where the transistor 31 is connected, and therefore when the transistor 31 is in the OFF state, the A/D converter 70 is not connected to the power line 5. That is, even if the reception data extraction process is performed by using a voltage that is detected in an OFF period of the transistor 31, obtained data is invalid. Therefore, as described above, the reception data extraction process is performed on a voltage that is detected in the ON-period of the transistor 31. Thereby, data reception from the power line 5 is more reliably achieved.

### Fifth Embodiment

FIG. 7 is a block diagram illustrating a configuration of a power supply device 6E according to a fifth embodiment. The power supply device 6E can be also combined with the main body circuit 2 (see FIG. 1).

The power supply device 6E has a configuration similar to that of the power supply device 6D described above (see FIG. 6), but the line driver 350 (see FIG. 6) is not provided. Additionally, the PLC processing circuit 110 is connected to the control circuit 32, so that the baseband signal generated by the PLC processing circuit 110 is supplied to the control circuit 32. The other parts of the configuration of the power supply device 6E are basically the same as those of the power supply device 6D described above.

In the power supply device 6E, the control circuit 32 controls the transistor 31 in accordance with the baseband signal (therefore, in accordance with the transmission data Dt). As a result, the transmission data Dt is transmitted to the power line 5 (see FIG. 1).

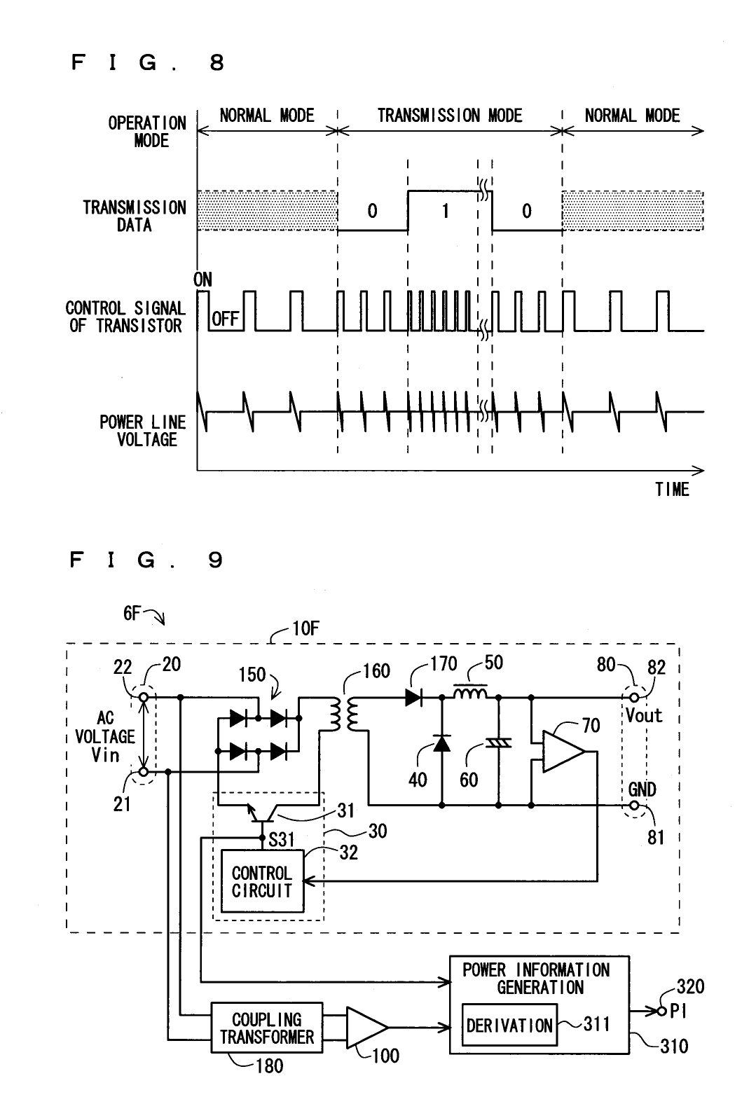

To be more specific, such a phenomenon that noise occurs in the voltage Vin of the power line 5 in response to the switching of the transistor 31 is used (see FIG. 8). More specifically, the control circuit 32 modulates the switching operation of the transistor 31 in accordance with the above-described transmission baseband signal that is supplied from the PLC processing circuit 110, and thereby causes intended noise in accordance with the transmission baseband signal (thus, in accordance with the transmission data Dt) to occur on the power line 5. Such intended noise enables the transmission data Dt to be delivered onto the power line 5.

In a case illustrated herein, in performing switching modulation, a switching cycle different from the switching cycle adopted when no data transmission is performed (hereinafter referred to as “normal mode”, whereas a mode in which data transmission is performed will be referred to as “transmission mode”) is used, and different switching cycles are used for data “0” and data “1”. For example, as shown in FIG. 8, a switching cycle corresponding to the data “0” is set shorter than a switching cycle in the normal mode, and a switching cycle corresponding to the data “1” is set shorter than the switching cycle corresponding to the data “0”. Since noise is generated on the power line 5 in synchronization with the switching cycle, the data “0” and “1” can be delivered onto the power line 5. Thus, the transmission baseband signal can be delivered onto the power line 5.

Since the reception operation is performed in the normal mode, the normal mode may be also referred to as a reception mode, a reception waiting mode, and the like.

The power supply device 6E exerts the same effects as those of the power supply device 6D described above (see FIG. 6).

In the power supply device 6E, data transmission through PLC can be performed by using the switching operation of the transistor 31 of the power supply circuit 10. That is, the power source function and a PLC transmission function share the switching circuit 30. Therefore, the line driver 350 (see FIG. 6) is not necessary. As a result, the cost, size, power consumption, and the like, can be reduced accordingly.

As described above, in the transmission mode, the transistor 31 is switched in order to cause noise in accordance with the transmission data to occur on the power line 5. However, even in this switching, the input voltage Vin is chopped and sent to a subsequent stage. Accordingly, although it is possible to switch the transistor 31 only for the purpose of data transmission, an appropriate control of the switching in the transmission mode enables the predetermined voltage value of the output voltage Vout, which is obtained in the normal mode, to be also obtained in the transmission mode, too.

More specifically, the control circuit 32 switches the transistor 31 in the transmission mode, under conditions that allow a predetermined voltage value that is generated in the normal mode to be obtained while modulation in accordance with the transmission data is performed. Thereby, a stable voltage Vout can be generated irrespective of an operation mode. This contributes to a high reliability.

More specifically, the above-mentioned conditions can be satisfied by setting the ON duration of the transistor 31 such that the ON duration decreases as the switching cycle is shorter.

The switching cycle may be set in the manner opposite to an example shown in FIG. 8, that is, the switching cycle corresponding to data “0” may be set shorter than the switching cycle corresponding to the data “1”.

Also, the switching cycle in the normal mode may be set shorter than the switching cycle in the transmission mode (that is, the switching cycles corresponding to data “0” and “1”). As the switching cycle decreases (that is, as the switching frequency increases), an interval of occurrence of noise becomes shorter, which may sometimes uniformize a voltage variation (in other words, noise) in the power line 5. In this case, noise corresponding to the transmission data is superimposed on the uniformized voltage. This facilitates detection of the transmission data.

For a transmission operation, a so-called chirp waveform is adoptable for the control signal S31 of the transistor 31.

The chirp waveform is a waveform in which a frequency (in other words, a cycle) varies linearly with elapse of time. A time factor in a frequency change is called a chirp rate. The adopted chirp waveform may be an up-chirp waveform in which the frequency increases with elapse of time, or may be a down-chirp waveform in which the frequency decreases with elapse of time. Different rates of the frequency change are assigned to the data “0” and the data “1”.

In general, a chirp signal allows communication with excellent noise tolerance. Therefore, in the power supply device 6E as well, such an effect is obtained.

It is also possible to add the PLC function to the power supply device 6B, 6C (see FIGS. 4 and 5) or the like by an application of the various configurations described above.

### Sixth Embodiment

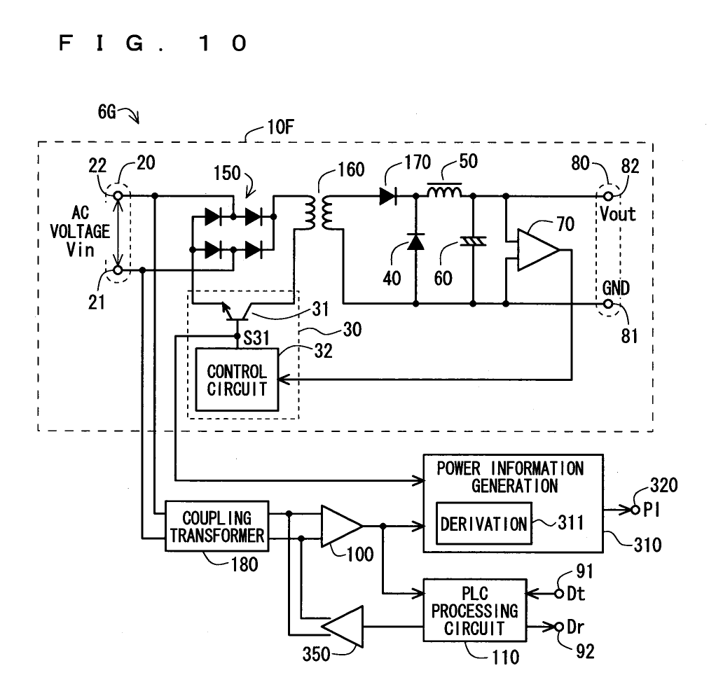

FIG. 9 is a block diagram illustrating a configuration of a power supply device 6F according to a sixth embodiment. The power supply device 6F can be also combined with the main body circuit 2 (see FIG. 1).

As shown in FIG. 9, the power supply device 6F includes a power supply circuit 10F. The power supply circuit 10F illustrated in FIG. 9 is an AC/DC converter, which is classified into an isolated type, a switching type, and a step-down type. In an example shown in FIG. 9, the power supply circuit 10F has a configuration in which a rectifier circuit 150, a transformer 160, and a diode 170 are additionally provided to the power supply circuit 10 described above (see FIG. 2). Since the power supply circuit 10F is an AC/DC converter as mentioned above, an AC voltage Vin is applied to the voltage input terminal 20 while a DC voltage Vout is provided to the voltage output terminal 80.

In the example shown in FIG. 9, the rectifier circuit 150 is a full-wave rectifier circuit of bridge type. However, a configuration of the rectifier circuit 150 is not limited to this example. In the example shown in FIG. 9, the rectifier circuit 150 has one input end thereof connected to the voltage input terminal 21, the other input end thereof connected to the voltage input terminal 22, one output end thereof connected to one end of a primary winding of the transformer 160, and the other output end thereof connected to the emitter of the transistor 31.

In the transformer 160, the one end of the primary winding is connected to the one output end of the rectifier circuit 150 as described above, and the other end of the primary winding is connected to the collector of the transistor 31. In the transformer 160, one end of a secondary winding is connected to an anode of the diode 170, and the other end of the secondary winding is connected to the anode of the diode 40.

The diode 170 has the anode thereof connected to the one end of the secondary winding of the transformer 160 as described above, and a cathode thereof connected to the cathode of the diode 40.

A configuration from the diode 40 to the voltage output terminal 80 is the same as that of the power supply circuit 10 described above (see FIG. 2).

In the power supply device 6F as well, the transistor 31 chops a voltage of the voltage input terminal 20 side, but the chopping is performed on a voltage obtained after being applied to the voltage input terminal 20 and passing through the rectifier circuit 150.

The power supply device 6F illustrated in FIG. 9 includes the A/D converter 100 and the power information generation means 310 similarly to the power supply device 6 described above (see FIG. 2), and further includes a coupling transformer 180.

The coupling transformer 180 is connected to the voltage input terminal 20 and to the input end of the A/D converter 100, and acts as a so-called insulating transformer.

In the power supply device 6F, the A/D converter 100 detects a secondary-side voltage of the coupling transformer 180 (it is to be noted that the side connected to the voltage input terminal 20 is defined as the primary side). In this configuration as well, similarly to the power supply device 6 described above (see FIG. 2), the A/D converter 100 detects a voltage before the chopping is performed by the transistor 31.

Thus, the power supply device 6F is an example of an application of the configuration of the power supply device 6 described above (see FIG. 2) to an AC/DC converter (that is, the power supply circuit 10F). The power information generation means 310 of the power supply device 6F is operated in the same manner as that of the power supply device 6 described above, and thereby the same effects as those of the power supply device 6 described above are obtained.

It may be also acceptable that the A/D converter 100 is provided so as to lead to the secondary side of the transformer 160. More specifically, it may be acceptable that one input end of the A/D converter 100 is connected to the one end of the secondary winding of the transformer 160, and the other input end of the A/D converter 100 is connected to the other end of the secondary winding of the transformer 160. In this case, the A/D converter 100 detects the voltage obtained as a result of the chopping.

Therefore, the transformer 160 for use in power supply circuit also serves as the coupling transformer 180. This eliminates the need to provide the coupling transformer 180. Thus, the cost, size, and the like, can be reduced accordingly.

It may be also possible that an output of the A/D converter 100 that is connected to the secondary side of the transformer 160 is supplied to the control circuit 32, so that the control circuit 32 performs a feed-back control on the transistor 31 based on the output of the A/D converter 100. In this case, the A/D converter 70 that is connected to the voltage output terminal 80 can be removed. This exerts an effect of reducing the cost, size, power consumption, and the like.

The A/D converter 100 that is connected to the secondary side of the transformer 160 is connected at a position distant from the voltage output terminal 80. Therefore, in a case where the feed-back control is performed on the transistor 31 by using the detected voltage detected by the A/D converter 100, the obtained accuracy may sometimes not be the same as that obtained when the A/D converter 70 connected to the voltage output terminal 80 is used.

In such a case, it may be possible that the control circuit 32 estimates the output voltage Vout based on the detected voltage (originating from the input voltage Vin and corresponding to the input voltage Vin) detected by the A/D converter 100, and the feed-back control is performed on the transistor 31 based on this estimated voltage. The estimation of the output voltage Vout can be performed based on information of a circuit configuration between the A/D converter 100 and the voltage output terminal 80.

Use of an output voltage estimation process can ensure an accuracy of the feed-back control on the transistor 31, that is, a reliability of voltage conversion, even in a case where a circuit is interposed between the A/D converter 100 and the voltage output terminal 80. In other words, the degree of freedom in a position where the A/D converter used for the feed-back control on the transistor 31 is connected is increased.

It is also possible to adopt the power supply circuit 10F for the power supply device 6B, 6C (see FIGS. 4 and 5) or the like by an application of the various configurations described above.

### Seventh Embodiment

FIG. 10 is a block diagram illustrating a configuration of a power supply device 6G according to a seventh embodiment. The power supply device 6G can be also combined with the main body circuit 2 (see FIG. 1).

The power supply device 6G is an example of adding the PLC function to the power supply device 6F described above (see FIG. 9), and in other words, an example of applying the configuration of the power supply device 6D described above (see FIG. 6) to the AC/DC converter (that is, to the power supply circuit 10F).

To be specific, the power supply device 6G has a configuration in which the data input terminal 91, the data output terminal 92, the PLC processing circuit 110, and the line driver 350 are additionally provided to the power supply device 6F described above (see FIG. 9). These elements 91, 92, 110, and 350 are provided in the same manner as in the power supply device 6D (see FIG. 6), except that the output end of the line driver 350 is connected to the secondary side of the coupling transformer 180.

The power supply device 6G exerts the same effects as those of the power supply device 6F described above (see FIG. 9), and also enables PLC to be performed by the power supply device 6G itself or the main body circuit 2 or the like that is connected to the power supply device 6G.

It may be also possible to adopt the power supply circuit 10F and the PLC function for the power supply device 6B, 6C (see FIGS. 4 and 5) or the like by an application of the various configurations described above.

<Modification>

Although a case where the power supply circuit 10 (see FIG. 2) or the like is step-down type one has been illustrated above, a power supply circuit of step-up type or of step-up/step-down type may be adoptable.

While the invention has been described in detail, the foregoing description is in all aspects illustrative and not restrictive. It is therefore understood that numerous modifications and variations not illustrated herein can be devised without departing from the scope of the invention.

### DESCRIPTION OF THE REFERENCE NUMERALS

5 power line
6, 6B-6G power supply device
10, 10F power supply circuit
20 voltage input terminal
31 switching means
32 control circuit
70, 100 voltage detector
80 voltage output terminal
110 PLC processing circuit
310 power information generation means
311, 311B, 311C derivation means
S31 switching control signal
PI power information

1. A power supply device comprising:
a power supply circuit that performs voltage conversion in which an input voltage applied to a voltage input terminal is converted into a voltage having a predetermined voltage value, and outputs the voltage obtained as a result of said voltage conversion to a voltage output terminal; and
a power information generation part for generating power information concerning power that is outputted from said voltage output terminal, wherein
said power supply circuit includes:
a switching part for, by a switching operation thereof, chopping a voltage of said voltage input terminal side; and
a control circuit that controls said switching operation of said switching part,
said power information generation part generates said power information based on a content of said switching operation.

2. The power supply device according to claim 1, wherein
said control circuit controls said switching operation by giving a switching control signal to said switching part,
said power information generation part includes a derivation part in which the relationship between predetermined information and said power information is defined, said predetermined information including at least the content of said switching operation,
said power information generation part acquires said switching control signal and derives said power information by applying the content of said switching operation obtained from said switching control signal to said derivation part.

3. The power supply device according to claim 2, further comprising a voltage detector that is arranged to detect a voltage before said chopping is performed, wherein
said predetermined information further includes a voltage value of a portion detected by said voltage detector,
said power information generation part derives said power information by applying the voltage value detected by said voltage detector and the content of said switching operation to said derivation part.

4. The power supply device according to claim 2, further comprising a voltage detector that is arranged to detect a voltage obtained after said chopping is performed, wherein
said predetermined information further includes a voltage value of a portion detected by said voltage detector,
said power information generation part derives said power information by applying the voltage value detected by said voltage detector and the content of said switching operation to said derivation part.

5. The power supply device according to claim 4, wherein
said voltage detector is arranged to detect a voltage of said voltage output terminal.

6. The power supply device according to claim 4, wherein
said control circuit performs a feed-back control on said switching operation based on said voltage value detected by said voltage detector.

7. The power supply device according to claim 2, wherein
said power supply circuit is a DC/DC converter,
said predetermined information includes only the content of said switching operation,
said power information generation part generates said power information by using said derivation part and based only on the content of said switching operation obtained from said switching control signal.

8. The power supply device according to claim 1, wherein
power line communication (PLC) is performed by using a power line that leads to said voltage input terminal.

9. The power supply device according to claim 3, wherein
power line communication is performed by using a power line that leads to said voltage input terminal,
said power supply device further comprises a PLC processing circuit that performs a reception data extraction process in which data transmitted from another device to said power line is extracted from said voltage value detected by said voltage detector.

10. The power supply device according to claim 4, wherein
power line communication is performed by using a power line that leads to said voltage input terminal,
said power supply device further comprises a PLC processing circuit that performs a reception data extraction process in which data transmitted from another device to said power line is extracted from said voltage value detected by said voltage detector.

11. The power supply device according to claim 8, wherein
said control circuit modulates said switching operation in accordance with the data transmitted through said PLC.

12. The power supply device according to claim 9, wherein
said control circuit modulates said switching operation in accordance with the data transmitted through said PLC.

13. The power supply device according to claim 10, wherein
said control circuit modulates said switching operation in accordance with the data transmitted through said PLC.
